(19) United States
(12) Patent Application Publication
(10) Pub. No.: US 2024/0000110 A1
(43) Pub. Date: Jan. 4, 2024

(54) METHODS OF ENHANCING PALATABILITY AND/OR REDUCING SUGAR IN WET PET FOODS

(71) Applicant: Société des Produits Nestlé S.A., Vevey (CH)

(72) Inventors: Isabelle Lescieux, Aubigny (FR); Pascal Vanacker, Aubigny (FR)

(21) Appl. No.: 18/333,294

(22) Filed: Jun. 12, 2023

Related U.S. Application Data
(60) Provisional application No. 63/357,871, filed on Jul. 1, 2022.

(51) Int. Cl. A23K 50/48; A23K 10/30; A23K 20/142

(52) U.S. Cl. CPC A23K 50/48; A23K 10/30; A23K 20/142

(57) ABSTRACT

A method of making a wet food formulated for administration to a pet includes incorporating at least one of spinach or tomato into the wet food in an amount effective to enhance palatability of the wet food and/or reduce added sugar in the wet food. The method may include producing the wet food as a chunks-in-gravy composition and may include one or more of the following steps: (i) producing the gravy by a process comprising adding spinach to one or more other ingredients of the gravy; (ii) producing the gravy by a process comprising adding tomato to one or more other ingredients of the gravy, and preferably also incorporating free form cysteine into in the gravy; and (iii) producing the chunks by a process comprising adding both spinach and tomato to one or more other ingredients of the chunks. The method may include producing the wet food as a loaf composition, preferably by incorporating both spinach and tomato into the loaf composition.

### BACKGROUND

There are various ways of enhancing the palatability of comestible compositions. Addition of one or more ingredients that provide an appealing aroma or flavor may increase palatability. Ingredients that affect food qualities such as aroma, flavor, texture, or mouthfeel, may also affect palatability. For some compositions, increasing sweetness or increasing fat or salt content may enhance palatability for some animals. Flavor enhancers, such as glutamic acid or its salts and various nucleotide or ribonucleotide compounds, are also known in the art to be palatability enhancers.

The existing solutions for palatability enhancement in wet food for cats, such as chunks-in-gravy compositions, are usually based on Maillard reaction precursors. These precursors are composed of carbonyl, nitrogen and sulfur compounds such as amino acids, vitamins, and reducing sugars that may be incorporated in the chunks and/or into the gravy. However, using high inclusion rates of these components may be perceived negatively by pet owners because these components are classified as non-natural or may be perceived as potentially having a negative effect on pet health.

### SUMMARY

To the best knowledge of the present inventors, spinach has never been characterized as enhancing consumption or preference for a pet food in which it is included. To the contrary, spinach is a known astringent food. Oral astringency is perceived as a long-lasting puckering, shrinking, rough, and drying sensation in the oral cavity. Typically, this sensation limits consumption and preference. The key astringent compounds in spinach (Spinacia oleracea) are various glycosides and glucuronides of flavanols, and the specific compounds involved are flavon-3-ol-O-glycosides.

Further in this regard, spinach is a known bitter food. Peptides, alkaloids, saponins, and oxalates are typically evoked to explain its bitterness; but growth temperature, fertilizers, and water stress may also significantly affect the perceived bitterness of spinach. Cats are known to be generally receptive and negatively respond to bitterness in food.

Moreover, spinach is known to contain thylakoids. Thylakoid membranes derived from green leaf chloroplasts affect appetite-regulating hormones, suppress food intake, reduce blood lipids and lead to a decreased body weight in animals and human subjects. Studies support the hypothesis that thylakoids reduce the feeling of hunger by increasing postprandial cholecystokinin and leptin and decreasing serum ghrelin; the effect was shown with model animals as well. A reduced urge for palatable food was also shown.

These three qualities (astringency, bitterness and presence of thylakoids) should lead to a decreased food consumption and preference. Therefore, it was surprising for the present inventors to observe that spinach included in wet food for cats achieved a higher consumption and preference than control.

Accordingly, in some embodiments, the present disclosure provides a novel way to enhance the palatability of a chunks-in-gravy wet cat food product, by adding dried spinach in powder form or as flakes into the gravy and/or the chunks. Additionally or alternatively, a tomato powder may be added into the gravy and/or the chunks. In experimental testing, the increased palatability from the spinach and/or tomato was observed in average percentage consumption versus the control and versus a competitor product.

Advantageously, some embodiments of the present disclosure enhance the palatability of wet food for cats using addition of a natural ingredient, without increasing inclusion of Maillard reaction precursors. In some embodiments, dried spinach flakes are added to the gravy of a chunks-in-gravy composition, and the dried spinach flakes are only made with fresh harvested and selected leaves which have been washed with tap water, air-dried and cut, without addition of any other substances, such as anti-caking compounds, colorants, flavorings, preservatives, antioxidants, and/or sugars.

In some embodiments, the method further comprises incorporating soy sauce in addition to at least one of tomato or spinach, into the wet food for cats.

Additional features and advantages are described herein and will be apparent from the following Detailed Description and the Figures.

### DETAILED DESCRIPTION

As used in this disclosure and the appended claims, the singular forms “a,” “an” and “the” include plural referents unless the context clearly dictates otherwise. Thus, for example, reference to “a gravy” or “the gravy” includes a single gravy and also two or more gravies.

The words “comprise,” “comprises” and “comprising” are to be interpreted inclusively rather than exclusively. Likewise, the terms “include,” “including” and “or” should all be construed to be inclusive, unless such a construction is clearly prohibited from the context. However, the compositions disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein may be combined with any other embodiment disclosed herein unless expressly stated otherwise.

The terms “at least one of” and “and/or” used respectively in the context of “at least one of X or Y” and “X and/or Y” should be interpreted as “X without Y,” or “Y without X,” or “both X and Y.” Where used herein, the terms “example” and “such as,” particularly when followed by a listing of terms, are merely exemplary and illustrative and should not be deemed to be exclusive or comprehensive.

All percentages expressed herein are by weight of the total weight of the referenced composition unless expressed otherwise. As used herein, “approximately,” “about” and “substantially” refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number.

The terms “food,” “food product” and “food composition” mean a product or composition that is intended for ingestion by an animal and provides at least one nutrient to the animal. The term “animal” or “pet” means any animal which could benefit from or enjoy the food compositions and products provided by the present disclosure. For example, the pet may be an avian, bovine, canine, equine, feline, hircine, lupine, murine, ovine, or porcine animal. The pet may be any suitable animal, and the present disclosure is not limited to a specific pet animal. The term “companion animal” means a dog or a cat.

The term “pet food” means any composition formulated to be consumed by a pet. A “dry” food composition has less than 10 wt. % moisture and/or a water activity less than 0.64, preferably both. A “semi-moist” food composition has 11 wt. % to 20 wt. % moisture and/or a water activity of 0.64 to 0.75, preferably both. A “wet” food composition has more than 20 wt. % moisture and/or a water activity higher than 0.75, preferably both.

The term “chunks” means a plurality of separate food bodies, preferably meat pieces or restructured meat pieces which may have a pellet shape and simulate real meat chunks. The chunks may contain one or more of meat, meat by-products, cereals, or vegetable proteins. Non-limiting examples of chunks include particulates; pellets; pieces of pet food, dehydrated meat, meat analog, vegetables, and combinations thereof; and pet snacks, such as meat or vegetable jerky, rawhide, and biscuits. The chunks may vary in size depending upon the animal that will consume the product, e.g., the type, age, health, or size of the animal. For example, chunk sizes for cats typically range from 3 mm to 30 mm, preferably 8 mm to 20 mm, on the longest side. A “gravy” is a flowable edible composition that preferably comprises water and at least one of a starch or a gum, and preferably has the form of a gel or a sol.

The terms “loaf,” and “mousse” are used interchangeably herein. A loaf composition is a shaped or molded mass of pet food that preferably is substantially homogeneous. A loaf composition may have a structure that maintains, during and after removal from the packaging at ambient temperature and ambient pressure, the shape imparted on the loaf composition by the packaging. For example, in some embodiments, a loaf composition removed from a cylindrical can will have a cylindrical shape having a horizontal cross-section with substantially the same dimensions as a corresponding horizontal cross-section of the interior of the can.

The terms “chunk-in-loaf,” “HsCC,” “Heat Set Chunk Compound,” and “terrine” are used interchangeably herein. These terms refer to a loaf product with chunks added.

The term “enhanced palatability” and similar terms mean that at least one of spinach or tomato as disclosed herein improves the palatability of a food composition relative to an identically formulated food composition lacking the spinach/tomato. “Palatability” refers to a quality of a comestible composition that makes it appealing or pleasing to one or more of an animal's senses, particularly the senses of taste and smell. As used herein, whenever an animal shows a preference, for example, for one of two or more foods, the preferred food is more “palatable” and has greater “palatability.” For companion animals and other non-human animals, the relative palatability of one food compared to one or more other foods may be determined, for example, in side-by-side, free-choice comparisons, e.g., by relative consumption of the foods, or other appropriate measures of preference indicative of palatability.

The term “reduced sugar” and similar terms mean that at least one of spinach or tomato as disclosed herein reduces the amount of added sugar of a food composition relative to an identically formulated food composition lacking the spinach/tomato, while maintaining at least approximately the same palatability. In some embodiments, a pet food composition having “reduced added sugar” has no greater than about 5.0 wt. % added sugar, preferably no greater than about 2.0 wt. % added sugar, more preferably no greater than about 1.0 wt. % added sugar, most preferably approximately zero added sugar, relative to any sugar in the at least one of spinach and tomato.

The methods and compositions and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein may be used, the preferred devices, methods, articles of manufacture, or other means or materials are described herein.

Preferred embodiments provided by the present disclosure are described hereafter. An aspect of the present disclosure is a method of enhancing palatability of a wet pet food, such as a wet food for cats, for example a chunks-in-gravy composition or a loaf composition. The method comprises incorporating at least one of spinach or tomato into the wet pet food in an amount effective to increase palatability of the pet food relative to a pet food without the spinach and/or tomato but otherwise identically formulated. Additionally or alternatively, the method comprises incorporating at least one of spinach or tomato into the wet pet food in an amount effective to maintain the palatability of the wet pet food at least approximately the same, while decreasing the sugar content, relative to a wet pet food without the spinach and/or tomato and with a higher sugar content but otherwise identically formulated. In some embodiments, the method further comprises incorporating soy sauce, in addition to at least one of tomato or spinach, into the wet pet food.

A preferred embodiment of the wet pet foods disclosed herein is a chunks-in-gravy composition. In other embodiments, the pet food is a loaf or terrine composition.

Preferably at least a portion of the spinach is added to the wet pet food (e.g., added to the chunks, the gravy, and/or the loaf) as dried spinach flakes and/or dried spinach powder. The spinach flakes and/or the spinach powder may consist essentially of spinach and any residual moisture or consist of spinach and any residual moisture.

Preferably at least a portion of the tomato is added to the wet pet food (e.g., added to the chunks, the gravy, and/or the loaf) as dried tomato powder. The dried tomato powder may consist essentially of tomato, any residual moisture, and up to about 1.0 wt. % of any flow aid (such as potato starch) or consist of spinach and any residual moisture tomato, any residual moisture, and up to about 1.0 wt. % of any flow aid (such as potato starch).

In some embodiments of the method (e.g., to enhance palatability), an initial pet food formulation comprises at least one Maillard reaction precursor; and the method comprises adjusting the initial pet food formulation to include or increase an amount of at least one of spinach or tomato without increasing the amount of the at least one Maillard reaction precursor. In an embodiment, the adjusted pet food formulation has about the same amount of the ingredients, other than the spinach and/or tomato, relative to the initial wet pet food formulation. In another embodiment, the adjusted pet food formulation has less of the at least one Maillard reaction precursor and has about the same amount of the ingredients, other than the spinach and/or tomato and the at least one Maillard reaction precursor, relative to the initial wet pet food formulation. In some embodiments, the wet food is free or substantially free of any phosphate, or polyphosphate salts. Preferably the method further comprises producing a pet food according to the adjusted formulation, for example a cat food such as a wet food for cats. The method may further comprise sealing the pet food in a container and retorting the sealed container.

In some embodiments of the method (e.g., to reduce sugar), an initial pet food formulation comprises sugar; the method comprises adjusting the initial pet food formulation to replace at least a portion of the sugar with at least one of spinach or tomato; and the adjusted pet food formulation has about the same amount of the ingredients, other than the spinach and/or tomato and the sugar, relative to the initial wet pet food formulation. In some embodiments, the wet food does not comprise any added sugar relative to any sugar present in the at least one of spinach or tomato. Preferably the method further comprises producing a pet food according to the adjusted formulation, for example a cat food such as a wet food for cats. The method may further comprise sealing the pet food in a container and retorting the sealed container.

In some embodiments, a chunks-in-gravy composition may be made by including dried spinach powder and/or dried spinach flakes in the gravy at a total amount of about 0.1 wt. % to about 5.0 wt. % of the gravy, preferably about 0.1 wt. % to about 2.5 wt. % of the gravy, more preferably about 0.2 wt. % to about 2.0 wt. % of the gravy, even more preferably about 0.5 wt. % to about 1.5 wt. % of the gravy, most preferably about 1.0 wt. % of the gravy.

Additionally or alternatively, a chunks-in-gravy composition may be made by including tomato powder in the chunks in an amount of about 0.1 wt. % to about 5.0 wt. % of the gravy, preferably each about 0.1 wt. % to about 4.0 wt. % of the gravy, more preferably each about 0.2 wt. % to about 3.0 wt. % of the gravy, even more preferably each about 0.5 wt. % to about 2.5 wt. % of the gravy, most preferably each about 1.0 wt. % to about 2.0 wt. % of the gravy.

Additionally or alternatively, a chunks-in-gravy composition may be made by including both (i) at least one of dried spinach powder or dried spinach flakes and (ii) tomato powder in the chunks, each in an amount of about 0.1 wt. % to about 5.0 wt. % of the chunks, preferably each about 0.1 wt. % to about 4.0 wt. % of the chunks, more preferably each about 0.2 wt. % to about 3.0 wt. % of the chunks, even more preferably each about 0.5 wt. % to about 2.5 wt. % of the chunks, most preferably each about 1.0 wt. % to about 2.0 wt. % of the chunks.

In some embodiments, a chunks-in-gravy composition is made by including tomato powder and free form cysteine in the gravy, for example about 0.05 wt. % to about 0.5 wt. % free form cysteine in the gravy, preferably about 0.1 wt. % free form cysteine in the gravy, optionally with the amounts of tomato powder in the gravy disclosed earlier herein.

In some embodiments, a loaf composition may be made by including dried spinach powder and/or dried spinach flakes in the loaf at a total amount of 1%. Additionally or alternatively, a loaf composition may be made by including tomato powder in the loaf at a total amount of 1%.

In some embodiments, the wet pet food composition has no greater than about 2.0 wt. % of a polyphosphate or monophosphate compound, preferably no greater than about 1.0 wt. % monophosphate or polyphosphate, more preferably no greater than about 0.5 wt. % monophosphate or polyphosphate, most preferably approximately zero monophosphate or polyphosphate. Such monophosphate and polyphosphate compounds can include disodium diphosphate (or pyrophosphate), trisodium diphosphate (or pyrophosphate), tetrasodium or tetrapotassium diphosphate (or pyrophosphate), disodium phosphate, trisodium phosphate, dipotassium phosphate, potassium polyphosphate, sodium polyphosphate, sodium triphosphate, sodium tripolyphosphate, and pentasodium tripolyphosphate and others as known in the art.

The pet foods disclosed herein may be any food formulated for consumption by a pet such as a dog or cat. In an embodiment, the pet food provides complete nutrition as defined by the Association of American Feed Control Officials (AAFCO) and which depends on the type of animal for which the composition is intended (e.g., a dog or a cat). In another embodiment, the composition can be a supplement. Such a supplement can be added to a food composition or be administered in conjunction with a food composition, or administered separately.

The pet food comprising at least one of spinach or tomato (e.g., chunks-in-gravy or loaf) may be filled and sealed into a package. Non-limiting examples of suitable package types include cans, pouches, glass container, and plastic containers. Packaging of the pet food comprising at least one of spinach or tomato may comprise retorting the pet food in the package under time and temperature conditions sufficient for commercial sterilization. Typically, a retorting temperature of about 100° C. to 150° C. for approximately 5 to 90 minutes will produce a commercially sterile product. In some embodiments, the chunks or loaf may be mixed with one or more of gravy, gel, or condiment in the package before retorting.

In an embodiment, a suitable gravy may be prepared by heating a mixture of water, hydrocolloids (e.g., starch or gum), and condiments. Then the chunks and the gravy may be filled into the package in desired proportions. The ratio of the chunks to the gravy is preferably about 30:70 to about 70:30, for example about 40:60 to about 60:40.

Additionally or alternatively, the composition may be processed by one or more of refrigeration, freezing, frying, drying, aseptic processing, and/or another way to make the product shelf-stable. Then the product may then be packaged into any of a variety of different packages.

In another aspect of the present disclosure, a method of providing nutrition to a pet is provided. The pet may be a companion animal, preferably a cat. The method comprises administering a wet pet food made by any of the embodiments of the methods disclosed herein. For example, the method may comprise removing the pet food disclosed herein from a package and then administering the pet food to the pet.

In some embodiments, at least a portion of the tomato is tomato pomace.

In a preferred embodiment, the tomato is spray-dried tomato powder. For example, fresh, ripe tomatoes may be soaked in a vat and then transported to a spray-washing vat; following washing, the tomatoes may be sorted and crushed in a chopper to obtain tomato pulp.

The tomato pulp may then be process by “hot break” or “cold break.” If “hot break” is used, the tomatoes are preferably heated at 85° C. to 95° C. or above 90° C. prior to the crushing, and seeds and skin are removed prior to refinement of particle size. However, preferred embodiments use “cold break” processing in which the tomato pulp is held for less than a minute at temperatures of about 66° C. to 77° C. to obtain pectin.

The processed pulp provides a juice or paste which may be concentrated by an evaporator and then provided to a feeding tank to be pumped to the spray dryer, which may spray the juice or paste into a stream of hot air (e.g., 140° C. to 150° C.) and then cooled to form a dried powder. In some embodiments, the moisture content of the dried tomato powder is further reduced by a fluidized bed.

As noted above, a preferred embodiment of the pet foods disclosed herein is a chunks-in-gravy composition. In other embodiments, the pet food is a loaf or terrine composition.

In a chunks-in-gravy composition, preferably the chunks are approximately evenly distributed throughout the composition, and the gravy may be approximately evenly distributed throughout the composition. For example, a chunks-in-gravy composition may be substantially uniform such that similarly sized sections of the composition have substantially the same amount of the chunks by volume and/or substantially the same amount of the gravy by volume. The chunks and the gravy may be present throughout the composition; for example, although the chunks may be visually distinguished from the gravy, in some embodiments the composition does not have distinct layers.

In some embodiments, the chunks in the composition may be in the form of an emulsion of meat and/or vegetable protein that is sliced into separate pieces. Non-limiting examples of meat emulsions for use in the chunks of the compositions are disclosed in U.S. Pat. Nos. 10,993,445; 10,470,470; 7,736,686; 7,344,745; 6,767,573; 6,692,787; 6,649,206; 6,436,463; 6,379,738; 5,567,466; and 4,781,939; U.S. Pat. Pub. No. 2015/0208689 A1; and PCT Applications WO 2008085293 A2 and WO 2012057826 A1; all incorporated herein by reference in their entireties. Other non-limiting examples of suitable chunks include chunks of real meat, such as skeletal tissue and non-skeletal muscle from mammals, fowl and fish, for example beef, pork, chicken, turkey, lamb, fish or combinations thereof.

In some embodiments, the chunks in the composition may optionally comprise meat by-products, such as non-rendered clean parts, other than meat, derived from slaughtered mammals, fowl, or fish. In some embodiments, the chunks may comprise any of the meat by-products approved for use in animal foods, such as mechanically deboned beef, chicken or fish; beef and pork liver; lungs; kidney; and the like. Thus, the term “meat” as used herein refers to non-dehydrated meat and/or meat by-products, including frozen materials. The present disclosures is not limited to a specific meat or combination of meats, and any meat known to the skilled artisan for making a food composition may be used in the chunks.

The chunks may comprise other ingredients in addition to any meat. For example, additives used in conventional meat emulsion products may be included in the chunks by being mixed with the meat prior to and/or after emulsification. These additives include salt, spices, seasoning, sugar and the like, in amounts sufficient to provide the product with desired flavor characteristics.

One or more dry proteinaceous materials may be added to the meat prior to and/or after emulsification to improve emulsion stability and binding, impart flavor, and/or reduce formulation costs. Non-limiting examples of suitable dry proteinaceous materials are wheat gluten, soy flour, soy protein concentrate, soy protein isolate, egg albumin, nonfat dry milk and combinations thereof. The inclusion of the one or more dry proteinaceous materials in the emulsion may be advantageous because dry proteinaceous material enables the processor to use meat having a protein to fat ratio and myosin to total protein ratio which would otherwise be of marginal acceptability for use in preparing the chunks.

Nevertheless, in some embodiments, the chunks do not contain any meat. For example, vegetable protein may be used additionally or alternatively to any meat, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like.

The gravy may further comprise dextrose and/or xylose, and may also include a colorant as desired. Ingredients that add flavor and/or aroma to the gravy may also be included as desired. The starch in the gravy may be a native starch, a modified starch or a combination thereof; and suitable gums include locust bean gum, guar gum and xanthan gum.

In various embodiments, the chunks and/or the gravy may comprise additional ingredients such as vitamins, minerals, amino acids, nucleic acids, fillers, palatability enhancers, binding agents, flavorants, stabilizers, emulsifiers, sweeteners, colorants, buffers, salts, coatings, condiments, preservatives, and the like known to skilled artisans. The additional ingredients may be included in the chunks by being mixed with the meat prior to and/or after emulsification.

Non-limiting examples of supplementary vitamins include vitamin A, any of the B vitamins, vitamin C, vitamin D, vitamin E, and vitamin K, including various salts, esters, or other derivatives of the foregoing. Non-limiting examples of minerals include calcium, phosphorous, potassium, sodium, iron, chloride, boron, copper, zinc, magnesium, manganese, iodine, selenium, and the like. Additional dietary supplements may also be included, for example, any form of niacin, pantothenic acid, inulin, folic acid, biotin, amino acids, and the like, as well as salts and derivatives thereof.

Stabilizers include substances that tend to increase the shelf life or the structure of the pet food such as preservatives, synergists and sequestrants, packaging gases, emulsifiers, thickeners, gelling agents, and plasticizers. Examples of emulsifiers and/or thickening agents include gelatin, cellulose ethers, starch, starch esters, starch ethers, and modified starches.

Examples of suitable flavorants include yeast, tallow, rendered animal meals (e.g., poultry, beef, lamb, pork), flavor extracts or blends (e.g., grilled beef), and the like. Suitable colorants that may be used in the meat analog chunks and/or the gravy include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; iron oxides; and any suitable food colorant known to the skilled artisan. Suitable spices that may be used in the meat analog chunks and/or the gravy include parsley, oregano, sage, rosemary, basil, thyme, chives and the like.

Selection of the additional ingredients and their amounts is known to skilled artisans. Specific amounts for each additional ingredient will depend on a variety of factors such as the ingredient included in the composition; the species of animal; the animal's age, body weight, general health, sex, and diet; the animal's consumption rate; the purpose for which the food composition is being administered to the animal; and the like. Therefore, the component and ingredient amounts may vary widely and may deviate from the preferred proportions described herein.

In an embodiment, the chunks may be produced by emulsifying one or more of meat, dry proteinaceous materials, water and any additional ingredients. Optionally, the emulsion further comprises a flour such that the emulsion is a dough. Examples of suitable flours include wheat flour, amaranth flour, bean flour, white or brown rice flour, buckwheat flour, chestnut flour, chickpea flour, potato flour, corn flour, nut flour grated from oily nuts, pea flour, peanut flour, rye flour, tapioca flour, soy flour and the like. The chunks are not limited to a specific flour, and any flour known to the skilled artisan for making a dough may be used.

The emulsion may be formed using equipment commonly used in meat emulsification such as a mixer, a blender, a grinder, a silent cutter chopper, an emulsion mill, and the like. The other ingredients of the chunks may be added to the meat prior to and/or after emulsification of the meat. The emulsion may then be processed by a high-speed emulsion mill in a second emulsion step in which the emulsion is thermally gelled by rapid heating. The heated emulsion may then be cooled. For example, the heated emulsion may be discharged from the mill into a heat exchanger to lower the temperature of the emulsion and to solidify the emulsion into a striated meat-like structure.

The striated meat-like structure may be sliced into pieces to create the meat analog chunks. For example, a dicer, a rotary cut-off knife, a water jet knife, a knife grid or the like may cut the product into pieces of desired sizes. In an embodiment, portions of the striated meat-like structure may be processed differently to create pieces of different sizes.

In a preferred embodiment, the gravy is prepared separately from the chunks. For example, prior to mixing the gravy with the chunks, the gravy may be mixed by standard means well known in the art. In an embodiment, the gravy may be formed by adding the non-water components of the gravy to the water during continuous mixing, such as by a high-speed mixer, and the gravy may be formed at ambient temperatures. In another embodiment, the gravy may be formed by mixing the non-water components of the gravy in a portion of the water at ambient temperatures to form a slurry, heating the other portion of the water, and then adding the slurry to the heated water during continuous stirring, such as by an agitator.

In view of the preceding disclosures, an embodiment provided herein is a method of making a wet food formulated for administration to a pet, method comprising incorporating at least one of spinach or tomato into the wet food in an amount effective to enhance palatability of the wet food and/or reduce sugar in the wet food.

In some embodiments, the method comprises producing the wet food as a chunks-in-gravy composition. The incorporating of the at least one of spinach or tomato into the wet food may comprise at least one step selected from the group consisting of: (i) producing the gravy by a process comprising adding spinach to one or more other ingredients of the gravy; (ii) producing the gravy by a process comprising adding tomato to one or more other ingredients of the gravy, preferably further comprising incorporating free form cysteine into in the gravy; and (iii) producing the chunks by a process comprising adding both spinach and tomato to one or more other ingredients of the chunks. In some embodiments, the method comprises producing the wet food as a loaf composition, preferably by incorporating both spinach and tomato into the loaf composition.

In some embodiments, the method does not comprise adding sugar to the wet food other than any sugar present in the at least one of spinach or tomato, and/or the wet food is free or substantially free of any of added phosphate or polyphosphate salts such as diphosphate salt, e.g., trisodium diphosphate.

In some embodiments, the method comprises the wet food is formulated for administration to a cat, preferably for complete nutrition of the cat.

In some embodiments, the method further comprises incorporating soy sauce into the wet food.

Another embodiment is a method of making a product, the method comprising sealing the wet food in a container and then retorting the sealed container.

Another embodiment is a method of providing nutrition to a pet, the method comprising administering a wet food made by any method disclosed herein to the pet. The pet is preferably a cat. The pet may have or be at risk of renal failure, and the wet food may be free or substantially free of any of added phosphate or polyphosphate salts such as diphosphate salt, e.g., trisodium diphosphate.

### EXAMPLES

The following non-limiting examples further support the compositions and methods disclosed herein. Formulations and results are shown in Tables 1-5. “GiG” refers to chunks having the appearance of grilled meat and made by one or more of the methods disclosed in U.S. Pat. Nos. 10,993,445 and 10,470,470, incorporated herein by reference in their entireties, and includes the commercial product FANCY FEAST® (“FF”). “CiG” refers to chunks of real meat without artificial additives (except vitamins and minerals). “Loaf” refers to a mousse product. “HsCC” refers to a terrine product.

### Example 1

Table 1 shows the formulations for control (no tomato powder in gravy) and treatment (spray-dried tomato powder added to gravy at 1 wt. % of the gravy) for GiG chunks-in-gravy compositions using Purina Gourmet® Perle Les Filettines, 85-gram pouch, chicken variety.

TABLE 1

| | | |
|---|---|---|
| Dextrose % | Xylose % | Tomato Powder % |

Chunks Formulation

| | | | |
|---|---|---|---|
| Control | 0.30 | — | — |
| Test | 0.30 | — | — |

Gravy Formulation

| | | | |
|---|---|---|---|
| Control | — | 0.11 | — |
| Test | — | 0.11 | 1.00 |

Final Product

| | | | |
|---|---|---|---|
| Control | 0.1 | 0.07 | — |
| Test | 0.1 | 0.07 | 0.62 |

Additionally, the test formulation of Table 1 provided significantly enhanced palatability relative to the control formulation over three trials with a 67%, 71.6%, and 69.3%, preference (p≤0.05). When tomato powder was added to the chunk alone, the palatability enhancement was limited and non-systematic and overall non-significant.

### Example 2

Dehydrated spinach was tested in two forms: flakes or powder and added in the gravy at 1%.

TABLE 2

| | | | |
|---|---|---|---|
| | | Spinach | Spinach |
| Dextrose % | Xylose % | Powder % | Flakes % |

Chunks Formulation

| | | | | |
|---|---|---|---|---|
| Control | 0.30 | — | — | — |
| Test 1 | 0.30 | — | — | — |
| Test 2 | 0.30 | — | — | — |

Gravy Formulation

| | | | | |
|---|---|---|---|---|
| Control | — | 0.11 | — | — |
| Test 1 | — | 0.11 | — | 1.00 |
| Test 2 | — | 0.11 | 1.00 | — |

Final Product

| | | | | |
|---|---|---|---|---|
| Control | 0.1 | 0.07 | — | — |
| Test 1 | 0.1 | 0.07 | — | 0.62 |
| Test 2 | 0.1 | 0.07 | 0.62 | — |

Comparative tests 1 and 2 versus the chunks-in-gravy control showed repeated significant enhanced palatability for the product containing the spinach flakes or the spinach powder with 68% preference for spinach flakes (Test 1) and 66% preference for spinach powder (Test 2) (p<0.05).

Adding the spinach flakes at 4% in the chunks did not significantly positively impact the palatability (p>0.05), but as shown in Table 3, combining spinach flakes and tomato powder at 1% each and 2% each in the chunks significantly enhanced palatability over the control (Purina Gourmet® Perle Les Filettines, 85-gram pouch, chicken variety). Surprisingly, tomato powder does not impact palatability when added solely at 4% in the chunks (results were not statistically significant) but combining spinach flakes and tomato powder creates a palatability boost (statistically significant, p<0.05). Enhanced palatability versus a competitor product (Sheba® Mini filets 85 grams pouch (France) (CiG)) was also shown when both tomato powder and spinach flakes were added at 1%. These results suggest that the combination of the two ingredients when added in the chunks generates the effect.

TABLE 3

| | | % Average |
|---|---|---|
| | | Consumption |
| Form | Inclusion: Components and amounts | Test vs Control |
| GiG | In chunks, 4% spinach (powder) | 54.2 |
| GiG | In chunks, 2% tomato (powder), | 60.4 |
| | 2% spinach (flakes) | |
| GiG | In chunks, 1% tomato (powder), | 66.8 |
| | 1% spinach (flakes) | |

### Example 3

Tomato powder at 1% of the gravy in a chunks-in-gravy cat food and tomato and spinach (0.5% each) in HSCC cat food were used as alternative to sugars (Table 4) leading to enhanced preference as compared to the baseline product (an HSCC having 78% moisture, 12% protein, 5.5% fat, 2.7% ash, 0.05% crude fiber) without added sugar.

TABLE 4

| | | Average % consumed vs. |
|---|---|---|
| Form | Description | Control with added sugar |
| CiG | Baseline w/o added sugar - Day 1 | 48 |
| CiG | Baseline w/o added sugar - Day 5 | 40 |
| CiG | Tomato 1% in gravy (Day 1) | 55 |
| CiG | Tomato 1% in gravy (Day 5) | 57 |

| | | Average % consumed vs |
|---|---|---|
| Form | Inclusion: Components and amounts | Control with added sugar |
| HsCC | No added sugar - No added | 34 |
| | spinach no added tomato - | |
| HsCC | No added sugar - 0.5% tomato | 47 |
| | powder, 0.5% spinach flakes | |

As shown also in Table 5, a synergistic preference effect in chunks-in-gravy was observed when combining tomato powder (1%) and cysteine (0.1%) in gravy. The control contained no added sugars.

TABLE 5

| | | Test vs. |
|---|---|---|
| Form | Description | Control |
| No added sugars CIG | Tomato 1% in gravy (1^{st} test) | 57.5 |
| No added sugars CIG | Cysteine 0.1% in gravy | 55 |
| No added sugars CIG | Tomato 1%, Cysteine 0.1%, in gravy | 67.5 |

It should be understood that various changes and modifications to the presently preferred embodiments described herein will be apparent to those skilled in the art. Such changes and modifications may be made without departing from the spirit and scope of the present subject matter and without diminishing its intended advantages. It is therefore intended that such changes and modifications be covered by the appended claims.

1. A method of making a wet food formulated for administration to a pet, method comprising incorporating at least one of spinach or tomato into the wet food in an amount effective to enhance palatability of the wet food and/or reduce added sugar in the wet food.

2. The method of claim 1, comprising producing the wet food as a chunks-in-gravy composition.

3. The method of claim 2, wherein the incorporating of the at least one of spinach or tomato into the wet food comprises producing the gravy by a process comprising adding spinach to one or more other ingredients of the gravy.

4. The method of claim 2, wherein the incorporating of the at least one of spinach or tomato into the wet food comprises producing the gravy by a process comprising adding tomato to one or more other ingredients of the gravy.

5. The method of claim 4, wherein the process of producing the gravy further comprises incorporating free form cysteine into in the gravy.

6. The method of claim 2, wherein the incorporating of the at least one of spinach or tomato into the wet food comprises producing the chunks by a process comprising adding both spinach and tomato to one or more other ingredients of the chunks.

7. The method of claim 1, comprising producing the wet food as a loaf composition.

8. The method of claim 7, wherein the producing of the wet food as the loaf composition comprises incorporating both spinach and tomato into the loaf composition.

9. The method of claim 1, wherein the method does not comprise adding sugar to the wet food other than any sugar present in the at least one of spinach or tomato.

10. The method of claim 1, wherein the wet food is formulated for administration to a cat.

11. The method of claim 1, further comprising incorporating soy sauce into the wet food.

12. A method of making a product, the method comprising sealing the wet food of claim 1 in a container and then retorting the sealed container.

13. A method of providing nutrition to a pet, the method comprising administering a wet food made by the method claim 1 to the pet.

14. The method of claim 13, wherein the pet is a cat.

15. The method of claim 13, wherein the pet has or is at risk of renal failure, and the wet food is free or substantially free of added phosphate or polyphosphate salts.
